(19) United States
(12) Patent Application Publication
(10) Pub. No.: US 2005/0114545 A1
(43) Pub. Date: May 26, 2005

(54) Method and apparatus for marking of web pages

(75) Inventors: Prabhakar Gopalan, Austin, TX (US); Kanmani Nachimuthu, Austin, TX (US); Lakshmi N. Potluri, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,089

(22) Filed: Nov. 20, 2003

(51) Int. Cl. G06F 15/16; G06F 15/173

(52) U.S. Cl. 709/245; 709/223

(57) ABSTRACT

A method, apparatus, and computer instructions for marking a Web page in a data processing system. A user input is received to mark a portion of the Web page displayed in the data processing system to form a marked portion. An identifier of the marked portion is stored in a local data structure in the data processing system. A subsequent retrieval of the Web page results in a presentation of the Web page with the marked portion. This presentation is made using the identifier stored in the local data structure.

### CROSS REFERENCE TO RELATED APPLICATIONS

The present invention is related to an application entitled Method and Apparatus for Marking of Web Page Portions for Revisiting the Marked Portions, Ser. No. 10/427,130, attorney docket no. AUS920030102US1, filed Apr. 30, 2003, assigned to the same assignee, and incorporated herein by reference.

### BACKGROUND OF THE INVENTION

1. Technical Field

The present invention relates generally to an improved data processing system and in particular, a method and apparatus for processing data. Still more particularly, the present invention provides a method, apparatus, and computer instructions for marking portions of a Web page so that those portions may be revisited at a later time.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

With the increased usage of the Internet as a source of information, the number of Web pages present on the Internet has increased dramatically. The Internet has hundreds of thousands of Web sites that may be visited by users of Web browser applications. Each of these Web sites may have a plurality of Web pages associated with them that may be visited by users of Web browsers.

When a user is searching for information on the Internet, the user may often visit a number of Web sites and a number of Web pages associated with these Web sites. Often, a user may desire to return to a Web page previously visited because a portion of the Web page may have been of interest to the user. However, the user must re-request the Web page and again attempt to locate the portions of the Web page that were of interest. With current Web browsers and Web sites, an ability for a user to mark portions of a Web page and have those marked portions for revisiting the Web page is absent. Thus, it would be beneficial to have an apparatus and method for marking portions of a Web page for later revisiting the Web page.

### SUMMARY OF THE INVENTION

The present invention provides a method, apparatus, and computer instructions for marking a Web page in a data processing system. A user input is received to mark a portion of the Web page displayed in the data processing system to form a marked portion. An identifier of the marked portion is stored in a local data structure in the data processing system. A subsequent retrieval of the Web page results in a presentation of the Web page with the marked portion. This presentation is made using the identifier stored in the local data structure.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in marking Web pages in accordance with a preferred embodiment of the present invention;

FIG. 5 is a diagram illustrating an entry in a mark-up table in accordance with a preferred embodiment of the present invention;

FIGS. 6A and 6B are diagrams illustrating a graphical user interface of a Web browser plug-in module for marking portions of a Web page in accordance with a preferred embodiment of the present invention;

FIG. 7 is a diagram illustrating a graphical user interface of a Web browser in which a marked portion of a Web page is highlighted in accordance with a preferred embodiment of the present invention;

FIG. 8 is a diagram of code for the Web page of FIG. 7 illustrating the anchor tags used to identify portions of the Web page in accordance with a preferred embodiment of the present invention;

FIG. 9 is a flowchart of a process for marking a portion of a Web page in accordance with a preferred embodiment of the present invention; and

FIG. 10 is a flowchart of a process for presenting a Web page in accordance with a preferred embodiment of the present invention.

### DETAILED DESCRIPTION OF THE PREFERRED EMBODIMENT

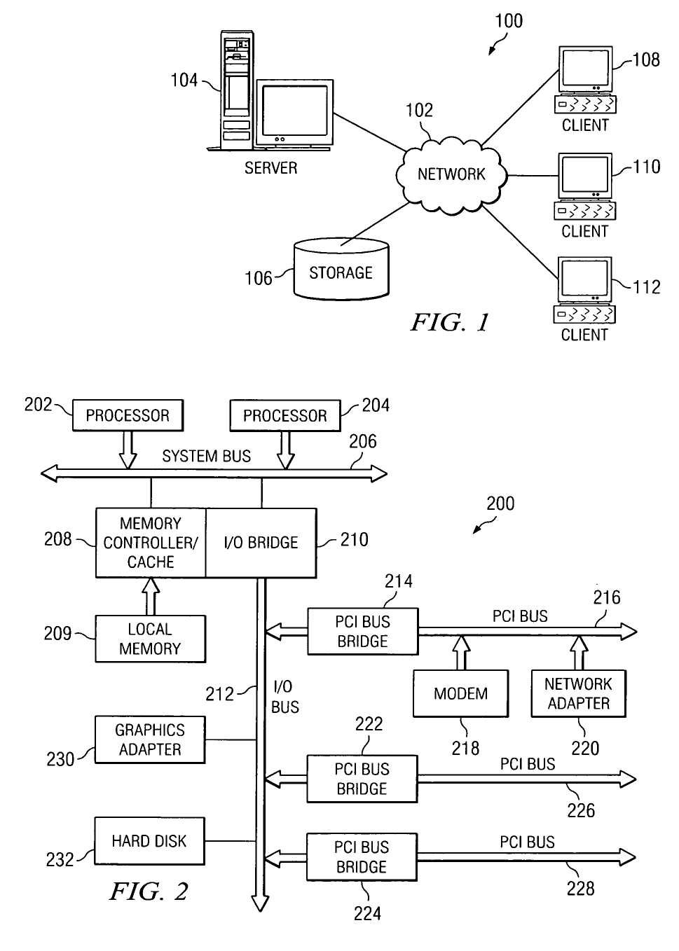

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In this particular example, server 104 may provide Web pages and other content to clients 108, 110, and 112. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

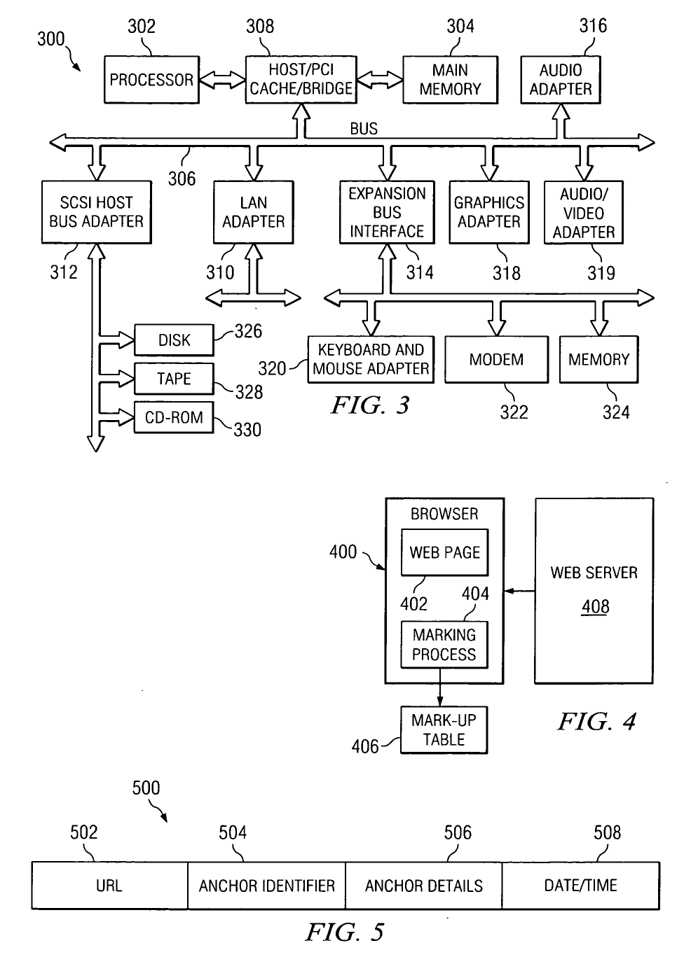

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

Data processing system 300 may take various forms, such as a personal digital assistant (PDA) device, which is configured with ROM and/or flash ROM in order to provide non-volatile memory for storing operating system files and/or user-generated data. The depicted example in FIG. 3 and above-described examples are not meant to imply architectural limitations. For example, data processing system 300 also may be a notebook computer, a kiosk, a Web appliance, or hand held computer in addition to taking the form of a PDA.

The present invention provides a method, apparatus, and computer instructions for marking portions of Web pages for subsequent revisits or retrievals of the Web pages. With the mechanism of the present invention, a user may mark a portion of a Web page using a graphical user interface provided for a Web browser on a client to select a portion of the Web page. This selection is stored locally on the client on the data structure, such as a table. The information stored is that needed to subsequently present the marked portion when the Web page is revisited. In the illustrative examples, anchor tags in the code for the Web page are used to identify the portion of the Web page selected by the user.

Turning next to FIG. 4, a diagram illustrating components used in marking Web pages is depicted in accordance with a preferred embodiment of the present invention. In this illustrative example, browser 400 receives Web page 402 which was requested from Web server 408. Browser 400 may be located on a client, such as data processing system 300 in FIG. 3, while Web server 408 may be located on a server such as data processing system 200 in FIG. 2.

Browser 400 is an application used to navigate or view information or data in a distributed database, such as the Internet or the World Wide Web. Browser 400 may be implemented using known browser applications, such as Microsoft Internet Explorer, which is available from Microsoft Corporation.

Browser 400 includes an additional process, marking process 404. This process is provided to facilitate marking portions of a Web page and representing the marked portions upon a subsequent retrieval upon a Web page. In the illustrative examples, marking process 404 is implemented as a plug-in to browser 400. A plug-in is an auxiliary program that works with a software application to enhance its capability. Plug-ins are added to Web browsers, such as browser 400, to enable them to support new types of content, such as audio and video. When implemented as a plug-in, marking process 404 may be turned on or off by the user during a browsing session. Depending on the implementation, marking process 404 may be implemented as part of browser 400, instead of as a plug-in.

A user may mark a portion of Web page 402. The marking may be accomplished using a graphical user interface with the user initiating an appropriate command to marking process 404 and selecting text. This command may be, for example, selection of an icon or button provided by browser 400. The selection of the text in Web page 402 may occur, for example, by pressing the right button on a mouse, scrolling along text simultaneously, and then releasing the right mouse button when the desired text has been highlighted. Graphics on Web page 402 may be selected in a similar fashion.

Upon selection of a portion of Web page 402, information used to identify the selected portion of Web page 402 is stored in a data structure, such as mark-up table 406. This information is, for example, tags or identifiers for tags in the selected portion of Web page 402. The location information, URL, for the Web page is stored in association with information used to identify the marked portion of Web page 402. In the illustrative examples, the URL is used in mark-up table 406 as an index to identify entries corresponding to Web page 402.

In the illustrative examples, mark-up table 406 may be, for example, a flat file, a data file, or any other data storage format. Each entry in mark-up table 406 identifies a portion of a Web page that has been marked. If multiple portions of Web page 402 are marked, each marked portion is identified in mark-up table 406 as a separate entry. Alternatively, all of the information may be stored in a single entry.

Upon a subsequent request for Web page 402, the entry corresponding to the marked portion of Web page 402 is used for special processing by browser 400. In this example, marking process 404 also functions to present Web pages with marked portions when those pages are subsequently requested. In response to receiving Web page 402 at a subsequent time, marking process 404 searches mark-up table 406 for entries corresponding to Web page 402. The URL for Web page 402 is used to search mark-up table 406 to determine whether an entry corresponding to a URL is present.

If an entry is present, the entry is used to present Web page 402. In particular, the identification of anchor tags in mark-up table 406 for the URL corresponding to Web page 402 is used to modify the code in Web page 402 to provide a presentation of the selected portion when Web page 402 is displayed by browser 400. Alternatively, marking process 404 may modify display information sent to the graphics adaptor.

The presentation of Web page 402 may take different forms. For example, the presentation includes conspicuously identifying the marked portions in a display of the Web page. This presentation may involve, for example, highlighting the marked portions, using a different text color, using a different text font type or size, or the like. Other special processing may include, for example, displaying only the marked portions, using speech synthesis (if available) to read marked portions of text to the user, jumping to marked portions of the Web page in response to an input from the user via the client device, and the like. For purposes of the present description, it will be assumed that the special processing is highlighting of the marked portions of the Web page. This special processing may be accomplished in a number of different ways. For example, marking process 404 may modify or add code to Web page 402, prior to Web page 402 being displayed by browser 400. However, those of ordinary skill in the art will readily understand in view of the present description, that other special processing may be utilized without departing from the spirit and scope of the present invention.

In this manner, a user may mark portions of the Web page of interest so that the user may easily identify these marked portions at a later time, such as during the same or different browsing session. The mechanism of the present invention also reduces the amount of time required to look up information in Web pages that have already been visited.

With reference now to FIG. 5, a diagram illustrating an entry in a mark-up table is depicted in accordance with a preferred embodiment of the present invention. In entry 500, the mark-up information includes URL 502, anchor identifier 504, anchor details 506, and date/time 508.

URL 502 is the URL corresponding to the Web page in which a portion has been marked. Anchor identifier 504 is an anchor name and/or number in this example. Anchor details 506 are, for example, the URL of the document and the title of the document. These details are identified by a marking process, such as marking process 400 in FIG. 4. Depending on the particular implementation, other information from the Web page may be used for anchor details 506. Date/time 508 is an identification of the date and time when the Web page was marked by the user.

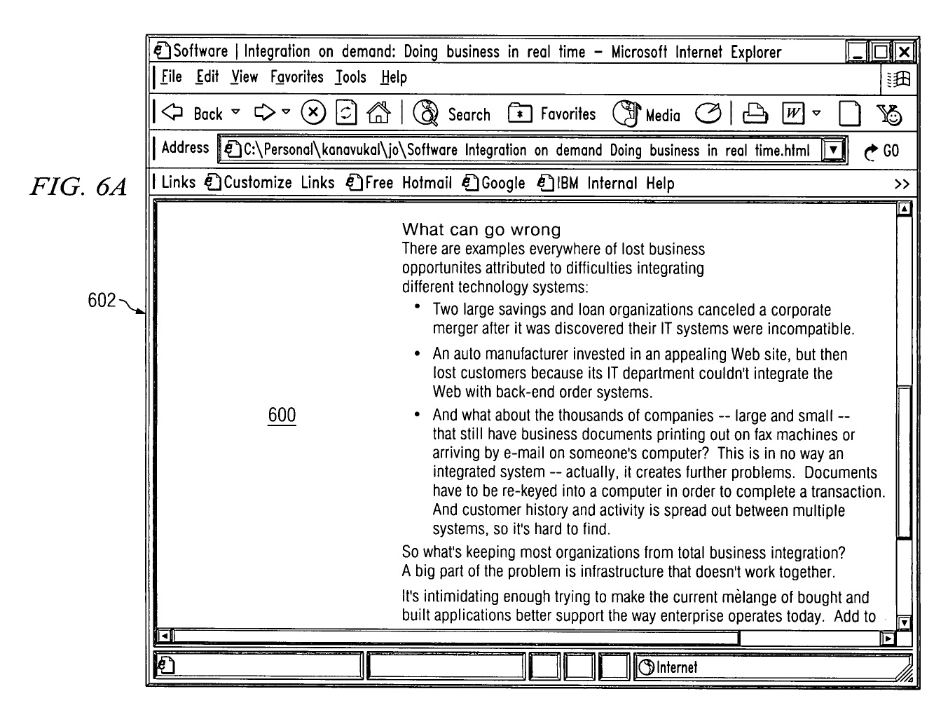

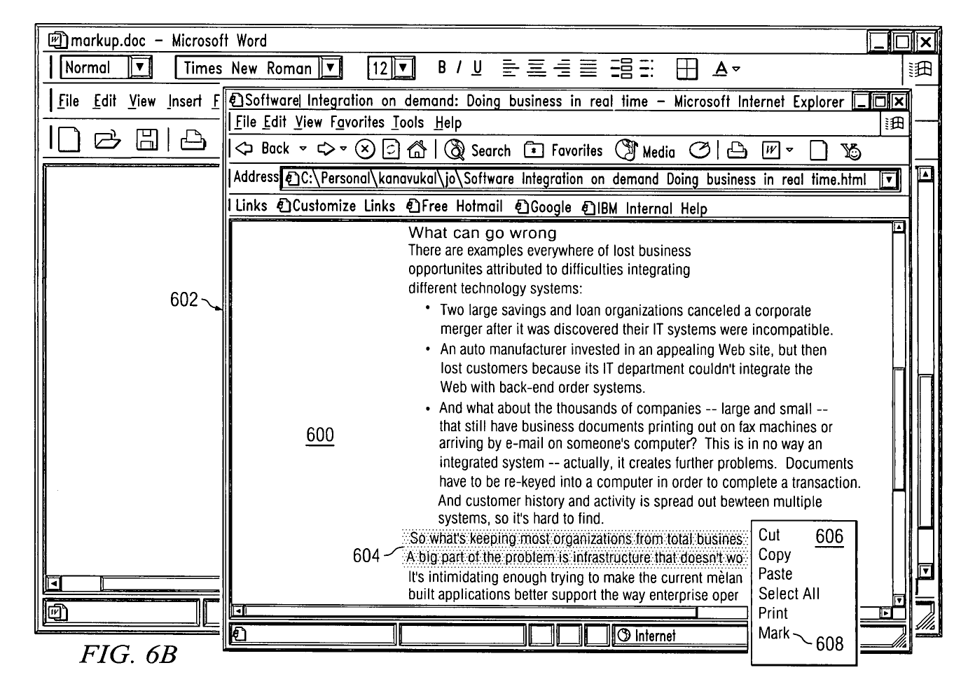

Next, FIGS. 6A and 6B are diagrams illustrating a graphical user interface of a Web browser plug-in module for marking portions of a Web page in accordance with a preferred embodiment of the present invention. FIG. 6A illustrates a display of Web page 600 using Web browser 602. FIG. 6B illustrates a graphical user interface of a Web browser plug-in module.

As shown in FIG. 6B, a user may highlight portion 604 of Web page 600 that is to be marked by selecting a beginning of portion 604 by pressing a mouse button and then dragging the mouse cursor across the portion of interest. The user may then use a right click operation to display the pop-up menu 606. As shown in FIG. 6B, this pop-up menu 606 includes mark option 608.

In response to selection of mark option 608, a marking process, such as marking process 404 in FIG. 4 for Web browser 602 identifies the anchor tags associated with the selected portion, portion 604, of Web page 600. The marking process then generates an entry in a mark-up table to store information, such as the anchor tags, identifying portion 604 as being a marked portion for Web page 600.

As a result, this information is stored in the mark-up table by the marking process for identifying the selected portion as being marked for special processing upon revisiting the Web page. The information stored in the table is then used in subsequent visits to the Web site for Web page 600 to accentuate the portions marked during previous requests for this Web page.

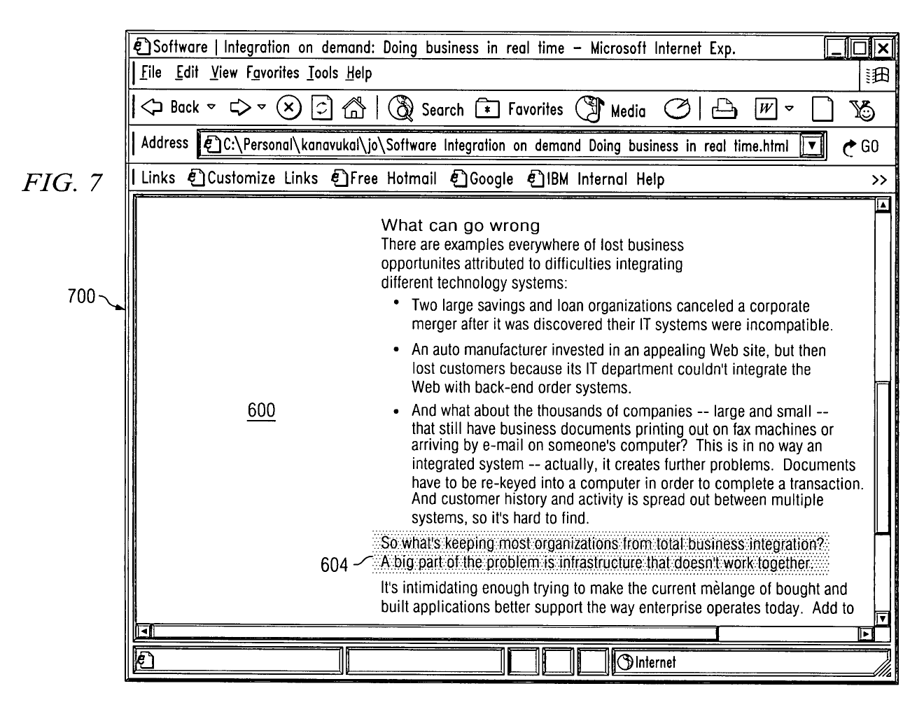

With reference to FIG. 7, a diagram illustrating a graphical user interface of a Web browser in which a marked portion of a Web page is highlighted is depicted in accordance with a preferred embodiment of the present invention. As shown in FIG. 7, upon a subsequent visit to the Web site and a request for the same Web page marked in the process shown in FIGS. 6A and 6B, Web page 600 is received by Web browser 700. In this illustrative example, browser 400 is launched during a later browsing session with respect to browser 602 in FIGS. 6A and 6B.

Web page 600 is identified as having previously marked portions by searching a mark-up table for an entry corresponding to the URL for Web page 600. The information in one or more entries corresponding to Web page 600 is used to insert identifiers for the marked portion, portion 604, of Web page 600. In the illustrative example, the identifiers are anchor tags that are recognized only by the marking process to perform special processing on portion 604. Alternatively, these identifiers may be, for example, additional code that causes portion 604 to be displayed in a special manner, such as highlighted in a different color, using a different font type, or using a different size. In the depicted example, the special processing involves highlighting the marked portion. Thus, the user's attention is immediately directed to the highlighted portion upon revisiting the Web page.

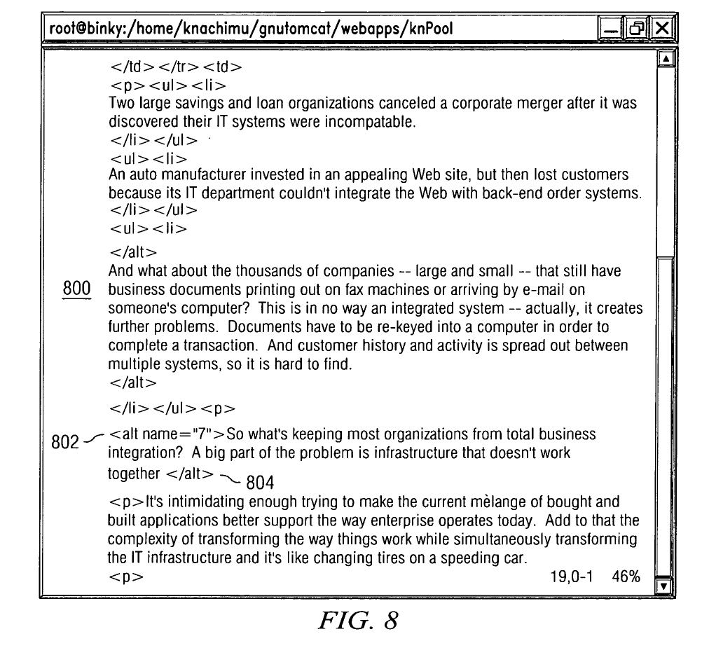

As mentioned above, in a preferred embodiment of the present invention, anchor tags are utilized to identify portions of a Web page. FIG. 8 is a diagram of code for the Web page of FIG. 7 illustrating the anchor tags used to identify portions of the Web page in accordance with a preferred embodiment of the present invention. As shown in FIG. 8, code 800 of the Web page includes anchor tags <alt> in lines 802 and 804, which are used to identify portions of the Web page. Although the <alt> tag is illustrated, any specific tag or custom tag may be used without departing from the spirit and scope of the present invention.

The <alt> tags may be enumerated in the mark-up table data structure and may be identified by an anchor tag number. This anchor tag number indicates the particular <alt> tag from the top of the Web page code. The anchor tag number uniquely identifies the tag within the Web page code and thus, can be used by the mark-up process to count the anchor tags in the Web page code from the top of the Web page code, until the identified number is encountered. Thus, the mark-up process may parse the Web page code and keep a count of how many of the anchor tags are identified. When the count reaches, for example, “7”, and the marked portion tag is anchor tag 7, the mark-up process may identify the portion of the Web page code between the seventh <alt> tag and the </alt> tag as the portion of the Web page that was marked by the user.

In addition to marking of portions of a Web page, as discussed in the examples above, the present invention may include an option for “unmarking” or “undoing” a mark operation in the same or subsequent visit to a Web page. The unmark option may be provided in a similar manner as discussed above with regard to the marking option. That is, a user of a Web browser application on a client device may select a portion of a displayed Web page by clicking and dragging a pointer icon across the selected portion.

A right click of the pointing device, for example, may then be used to access a pop-up menu that may have the “unmark” option enabled if the selected portion has been previously marked in the current or a previous visit to the Web page. By selecting the “unmark” option from the pop-up menu, the tags corresponding to the selected portion of the Web page are removed from the appropriate entries in the mark-up table indicating marked portions of the Web page.

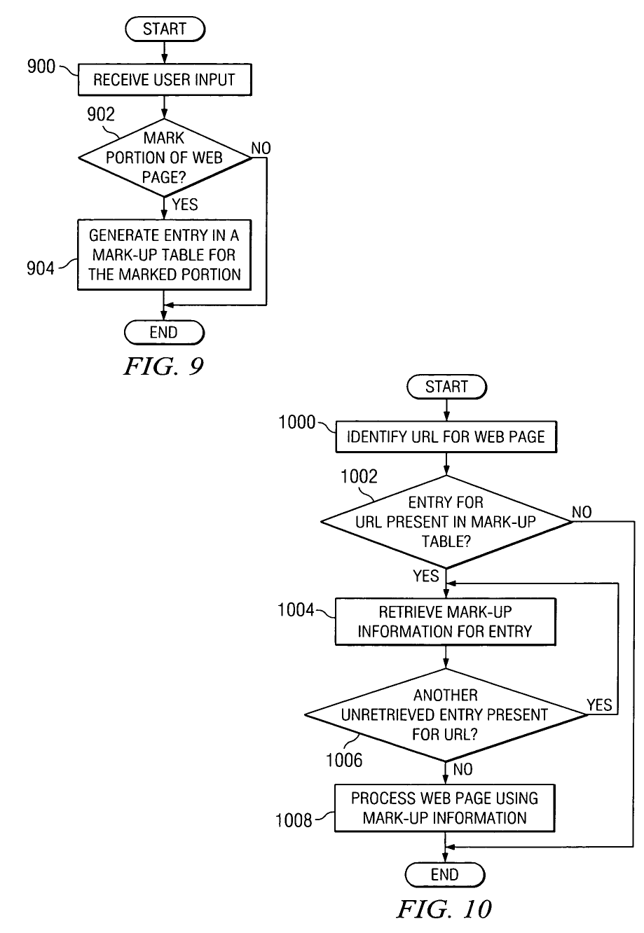

With reference next to FIG. 9, a flowchart of a process for marking a portion of a Web page is depicted in accordance with a preferred embodiment of the present invention. The process illustrated in FIG. 9 may be implemented in a marking process, such as marking process 404 in FIG. 4.

The process begins by receiving a user input (step 900). A determination is then made as to whether the user input marks a portion of the Web page (step 902). If the user input marks a portion of the Web page, an entry is generated in a mark-up table for the marked portion (step 904) with the process terminating thereafter. With reference again to step 902, if the user input does not mark a portion of the Web page, the process terminates.

With reference now to FIG. 10, a flowchart of a process for presenting a Web page is depicted in accordance with a preferred embodiment of the present invention. The process illustrated in FIG. 10 may be implemented in a mark-up process, such as mark-up process 404 in FIG. 4.

The process begins by identifying the URL for the Web page (step 1000). A determination is made as to whether this URL is present in the mark-up table (step 1002). If the URL is present in the mark-up table, mark-up information for the entry containing the URL is retrieved (step 1004). This mark-up information may include, for example, identification for an anchor as well as an anchor number.

Next, a determination is made as to whether another unretrieved entry is present in the mark-up table for the URL (step 1006). If another entry is present, the process returns to step 1004 as described above. Otherwise, the Web page is processed using the mark-up information (step 1008) with the process terminating thereafter. This processing is performed to present the marked portions when the Web page is displayed.

With reference again to step 1002, if an entry is not present in the mark-up table, the process ends and the Web page is displayed. In this case, the Web page is displayed normally by the Web browser without any processing being performed by the mark-up process.

Thus, the present invention provides a method, apparatus, and computer instructions for marking one or more portions of the Web page and for presenting those mark-up portions when the Web page is retrieved again at a later time. A user may select a portion of the Web page, such as text and/or graphics, for marking through a graphical user interface. Marking information used to identify the marked portions is stored in a data structure on the client side. This marking information is later used to present the Web page with the marked portions on the Web page when that Web page is subsequently retrieved.

Further, the mechanism of the present invention provides additional advantages through storing mark-up data in a mark-up table locally on the client, rather than on a server. For example, server space is freed up and transaction time for uploading a Web page is reduced. Also, redundancy on server side implementation specifics, such as the use of cookies and database modeling is reduced or eliminated. Further, the cost of developing and maintaining a server side mark-up system is avoided.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for marking a Web page, the method comprising:
receiving a user input to mark a portion of the Web page displayed in the data processing system to form a marked portion; and
storing an identifier of the marked portion in a local data structure in the data processing system, wherein a subsequent presentation of the Web page results in a presentation of the Web page with the marked portion.

2. The method of claim 1, wherein the Web page is a first Web page and further comprising:
responsive to receiving a second Web page, determining whether an entry corresponding to the second Web page is present in the local data structure; and
responsive to the entry being present, presenting the second Web page with at least one marked portion using the entry in the local data structure.

3. The method of claim 2, wherein the presenting step comprises:
displaying the Web page; and
using speech synthesis to read the marked portion.

4. The method of claim 2, wherein the presenting step comprises:
displaying only the marked portion.

5. The method of claim 1, wherein the local data structure is a table.

6. The method of claim 3, wherein each entry in the table includes a universal resource identifier, an anchor tag, and anchor tag details.

7. The method of claim 1, wherein the marked portion is marked using at least one of a different text color, and a different text size.

8. The method of claim 1, wherein the receiving step and the storing step are performed by at least one of Web browser and a plug-in to the Web browser.

9. A data processing system in a data processing system for marking a Web page, the data processing system comprising:
receiving means for receiving a user input to mark a portion of the Web page displayed in the data processing system to form a marked portion; and
storing means for storing an identifier of the marked portion in a local data structure in the data processing system, wherein a subsequent presentation of the Web page results in a presentation of the Web page with the marked portion.

10. The data processing system of claim 9, wherein the Web page is a first Web page and further comprising:
determining means, responsive to receiving a second Web page, for determining whether an entry corresponding to the second Web page is present in the local data structure; and
presenting means, responsive to the entry being present, for presenting the second Web page with at least one marked portion using the entry in the local data structure.

11. The data processing system of claim 10, wherein the presenting means comprises:
displaying means for displaying the Web page; and
using means for using speech synthesis to read the marked portion.

12. The data processing system of claim 10, wherein the presenting means comprises:
displaying means for displaying only the marked portion.

13. The data processing system of claim 9, wherein the local data structure is a table.

14. The data processing system of claim 11, wherein each entry in the table includes a universal resource identifier, an anchor tag, and anchor tag details.

15. The data processing system of claim 9, wherein the marked portion is marked using at least one of a different text color, and a different text size.

16. A computer program product in a computer readable medium for marking a Web page, the computer program product comprising:
first instructions for receiving a user input to mark a portion of the Web page displayed in the data processing system to form a marked portion; and
second instructions for storing an identifier of the marked portion in a local data structure in the data processing system, wherein a subsequent presentation of the Web page results in a presentation of the Web page with the marked portion.

17. The computer program product of claim 16, wherein the Web page is a first Web page and further comprising:
third instructions, responsive to receiving a second Web page, for determining whether an entry corresponding to the second Web page is present in the local data structure; and
fourth instructions, responsive to the entry being present, for presenting the second Web page with at least one marked portion using the entry in the local data structure.

18. The computer program product of claim 17, wherein the fourth instructions comprises:
first sub-instructions for displaying the Web page; and
second sub-instructions for using speech synthesis to read the marked portion.

19. The computer program product of claim 17, wherein the fourth instructions comprises:
sub-instructions for displaying only the marked portion.

20. The computer program product of claim 16, wherein the local data structure is a table.

21. The computer program product of claim 18, wherein each entry in the table includes a universal resource identifier, an anchor tag, and anchor tag details.

22. The computer program product of claim 16, wherein the marked portion is marked using at least one of a different text color, and a different text size.

23. A data processing system comprising:
a bus system;
a memory connected to the bus system, wherein the memory includes a set of instructions; and
a processing unit connected to the bus system, wherein the processing unit executes a set of instructions to receive a user input to mark a portion of the Web page displayed in the data processing system to form a marked portion; and store an identifier of the marked portion in a local data structure in the data processing system, wherein a subsequent presentation of the Web page results in a presentation of the Web page with the marked portion.
